(19) United States
(12) Patent Application Publication
(10) Pub. No.: US 2018/0136649 A1
(43) Pub. Date: May 17, 2018

(54) DRIVE 365

(71) Applicant: Lakesha Phillips, Toledo, OH (US)

(72) Inventor: Lakesha Phillips, Toledo, OH (US)

(21) Appl. No.: 15/350,059

(22) Filed: Nov. 13, 2016

(51) Int. Cl. G05D 1/00; G07C 5/00

(52) U.S. Cl. CPC G05D 1/0038; G07C 5/008; G05D 1/0016

(57) ABSTRACT

A system for remote-controlled driving of a vehicle without the intervention by the user travelling in the vehicle is disclosed. The remote-controlled driving system generally comprises of a local control component installed in the vehicle and a remote control station present at a location away from the vehicle. The local control component includes an integrated circuit which is connected to the driving operators of the vehicle, including the steering system, braking system, transmission system, and throttle system. The local control component communicates with the remote control station via satellite to send data necessary to drive the vehicle. A human operator monitors the views of the received data on the screens in the remote control station to drive the vehicle. The remote-controlled driving method is implemented as a subscription based remote-controlled driving service which can be paid for monthly, quarterly, annually or for a single journey.

### BACKGROUND

### Field

The present disclosure relates to driving systems and methods. More particularly, the present disclosure relates to a system for remotely controlled driving of a vehicle without intervention by the user travelling in the vehicle.

### Background

In some instances, people need to travel using their vehicle while they are not in a condition to drive, for example in case of a medical emergency. For these instances, people may employ the service of a chauffeur to drive their vehicle. However, some people may not prefer to use a chauffeur service as it may be unsafe and also too costly for certain trips. Also, sometimes a chauffeur service may not be readily available at the time of need. Recently, autonomous driving systems have been developed to drive a vehicle without the intervention of a driver. For example, U.S. Pat. No. 7,894,951 assigned to Deere Company, I robot Corporation on 2011, Feb. 22, discloses an actuator and controller based system for switching between autonomous and manual operation of a vehicle. U.S. Pat. No. 8,825,258 assigned to Google Inc. on 2014, Sep. 2, discloses a system to make a switch from the manual driving to the autonomous driving mode. U.S. Pat. No. 8,994,521 assigned to GM Global Technology Operations LLC on 2015, Mar. 31, discloses a system including a steering wheel assembly and an autonomous driving electronic control unit, to engage autonomous-mode steering for autonomous driving. However, these autonomous driving systems suffer from one or more limitations as they require a complex assembly for their implementation and hence, are expensive fora user. Also, the current autonomous driving systems that are run by computer assistance may have safety issues during a regular road journey.

Therefore, there is a need for an improved driving system which can be used anytime, anywhere for safe driving without intervention by a user travelling in the vehicle wherein the driving system utilizes a person remotely controlling the driving of the vehicle to ensure safe and reliable driving. It is also desired that the driving system can be easily switched to manual driving to allow the user sitting in the vehicle to drive if the remote controlled driving system is no longer needed.

It is an aspect of the disclosure to overcome or alleviate a problem of the prior art.

### SUMMARY

In view of the foregoing, one aspect of the various disclosed embodiments in the present disclosure is to provide a system for remotely driving of a vehicle without the intervention by the user traveling in the vehicle. The remotely-controlled driving system generally comprises of a local control component installed in the vehicle and a remote control station present at a location away from the vehicle. The local control component includes an integrated circuit which is connected to the driving operators of the vehicle, including the steering system, braking system, transmission system, and throttle system. The local control component communicates with the remote control station via satellite to send data necessary to drive the vehicle. A human operator monitors the views of the received data on the screens in the remote control station to drive the vehicle. The remotely-controlled driving method is implemented as a subscription based remotely-controlled driving service which can be paid for monthly, quarterly, annually or for a single journey.

In an example embodiment, the present disclosure provides a system for remotely-controlled driving that allows switching between remotely-controlled driving and manual driving.

In another example embodiment, disclosure provides a system for remotely-controlled driving that allows communication between a user traveling in a vehicle and an operator remotely driving the vehicle.

These together with other objects of the disclosure, along with the various features which characterize the disclosure, are pointed out with particularity in the disclosure. For a better understanding of the disclosure, its operating advantages and the specific objects attained by its uses, reference should be had to the descriptive matter in which there are illustrated preferred embodiments of the disclosure.

In this respect, before explaining at least one embodiment of the disclosure in detail, it is to be understood that the disclosure is not hunted in its application to the details of construction and to the arrangements of the components set forth in the following description. The disclosure is capable of other embodiments and of being practiced and carried out in various ways. Also, it is to be understood that the phraseology and terminology employed herein are for the purpose of description and should not be regarded as limiting.

These together with other objects of the disclosure, along with the various features of novelty which characterize the disclosure, are pointed out with particularity in the disclosure. For a better understanding of the disclosure, its operating advantages and the specific objects attained by its uses, reference should be made to the descriptive matter in which there are illustrated embodiments of the disclosure.

### BRIEF DESCRIPTION OF THE DRAWINGS

The disclosure will be better understood and objects other than those set forth above will become apparent when consideration is given to the following detailed description thereof.

FIG. 1 shows a remotely controlled vehicle via a remote station according to an example embodiment

FIG. 2 shows a control box with various components according to an example embodiment.

FIG. 3 shows a remote station with various components according to an example embodiment.

FIG. 4 shows a wireless connection between control box and remote station to control various driving parameters according to an example embodiment.

FIG. 5 shows a satellite enabled communication between remote station and the vehicle according to an example embodiment.

FIG. 6 (a) shows a flowchart explaining the remotely control mechanism according to an example embodiment.

FIG. 6 (b) shows a flowchart explaining the communication and security protocols during an emergency according to an example embodiment.

### DETAILED DESCRIPTION

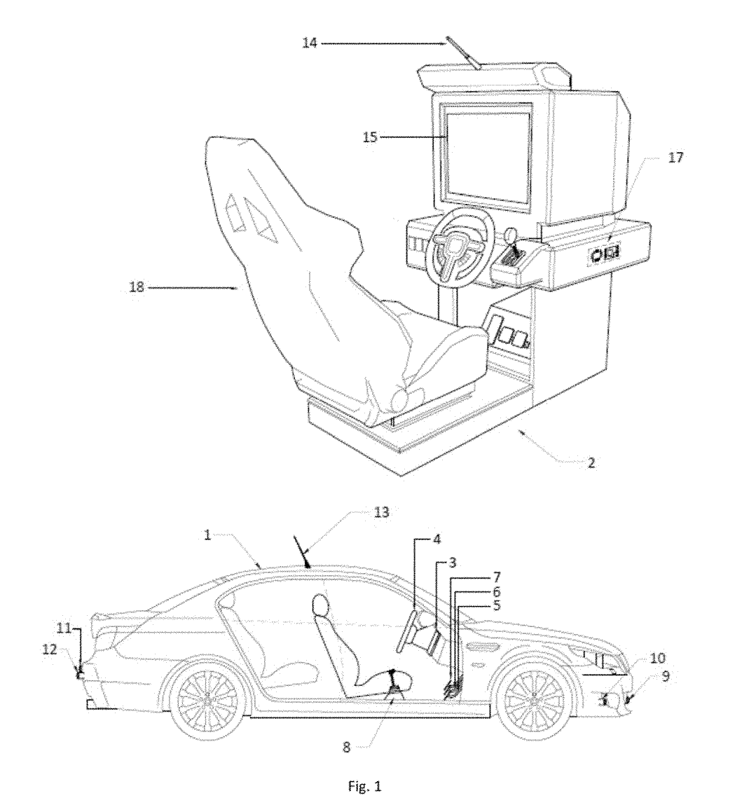

The following provide detailed description of the various embodiments. Those skilled in the art can understand that many changes can be made in the embodiments described, while still obtaining beneficial results of the present disclosure. It will also be apparent that some of the desired benefits of the present disclosure can be obtained by selecting some of the features of the disclosure while not utilizing other features. Accordingly, those working m the relevant au will recognize that many adaptations and modification to the present disclosure can be made and may be desired in certain circumstances, and are part of the present disclosure. The disclosure will be better understood and objects other than those set forth above will become apparent when consideration is given to the following detailed description thereof. FIG. 1 shows a diagram of the system architecture of remotely controlled vehicle via a remote station according to an example embodiment. A vehicle (1) is designed to be remotely controlled via a remote is station (2) and the remote station (2) includes various control parameters to drive the vehicle. The various control parameters includes a control box (3), a steering (4), an accelerator pedal (5), a brake pedal (6), a clutch pedal (7), a gear shift knob (8), a pair of front left camera (9) and right camera (10), a pair of rear left camera (11) and right camera (12), and an antenna (13). The of both front cameras (9, 10) and rear cameras (11, 12) provide real-time view of the road conditions of the vehicle (1) to a remote station (2). There are also various sensors (not shown in the figure) installed on the vehicle (1) to monitor various vehicle parameters such as an air pressure, fuel level and instantaneous speed. The real-time video signal captured by the pair of front and rear cameras and is transmitted by antenna (13) from the vehicle (1) to the remote station (2), where the same signals are intercepted by an antenna (14) installed on the remote station (2). The received signal is filtered and decoded to transform it into human readable form. Based on the traffic conditions S provided by the pair of cameras, an operator (18) positioned at the remote station (2) controls the various vehicle parameters with the help of a microcontroller associated with a storage unit (17) and the operator analyses the changes incurred in vehicle (1) motion in a display unit (15) installed in front of the operator in remote station (2).

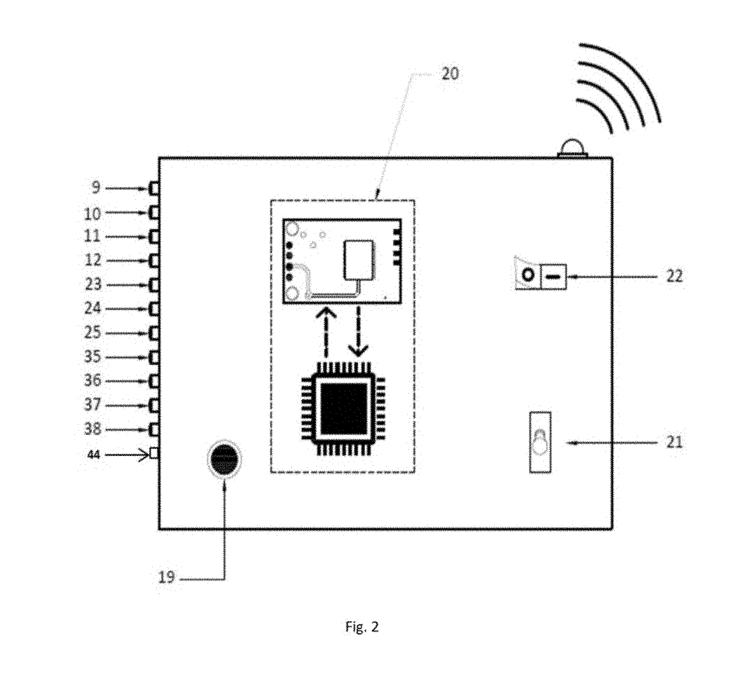

FIG. 2 shows control box and various components comprising microcontroller unit (20) associated with a storage module, a plurality of control switches, input lines for providing various commands as an input to the vehicle control box according to an example embodiment. The plurality of switches comprises an engine start/stop switch (19), an automatic drive mode select switch (21), a communication enable/disable switch (22) and plurality of input lines providing the status of vehicle parameters into the control box such input signal lines generated by pair of front and rear left-right cameras (9, 10, 11, 12), and input signal for other vehicle parameters such as fuel level signal (23) generated by a fuel level sensor, vehicle speed input signal (24) generated by a speed sensor and air pressure signal in all tires (25) generated by an air pressure sensor. The other four input lines are provided to receive a control signal in the form of feedback signal from the remote station (2) to control the various vehicle parameters to drive safely on the road. The feedback data received by the microcontroller unit (20) propagates in the form of various control data for controlling various parameters such as for acceleration pedal control (35), brake pedal control (36), clutch pedal control (37), gear knob shill control (38) and steering wheel control (44). All these parameters are interrelated to each other and the change in any of these parameters reflects the variations in other parameters. The communication enable/disable switch (22) is used to setup a communication between passenger and remote operator in emergency situations.

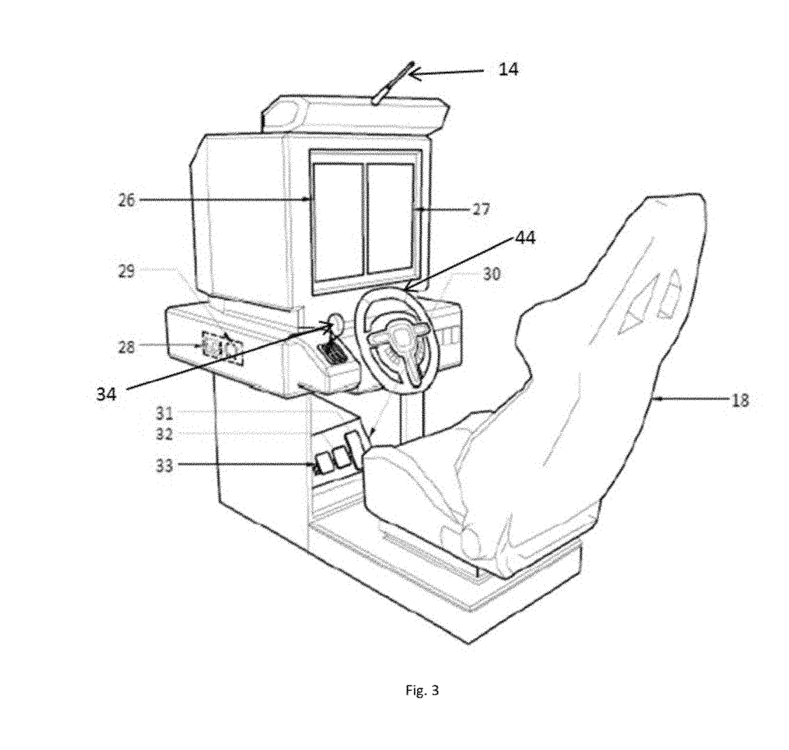

FIG. 3 shows an exemplary embodiment of remote station disclosing various components comprising a left display unit (26) coupled to front left cameras of the vehicle and a right display unit (27) coupled to front right cameras to provide areal three dimensional view in front of the operator (18), a microcontroller (28) coupled to both the display units (26, 27) and a storage module (29). The remote station (2) is associated with various control parameters to control vehicle movement remotely and these control parameters includes an accelerator pedal control (31), a brake control pedal (32), a clutch control pedal (33), a gear shift control knob (34) and a steering control wheel (44). All these control parameters are incorporated in a simulator control box (30) for their interconnection and interoperability. All these control signals that are generated by the operator positioned in the seat (18) based on input received by receiving antenna (14) and are sent back to the _{vehicle} control box.

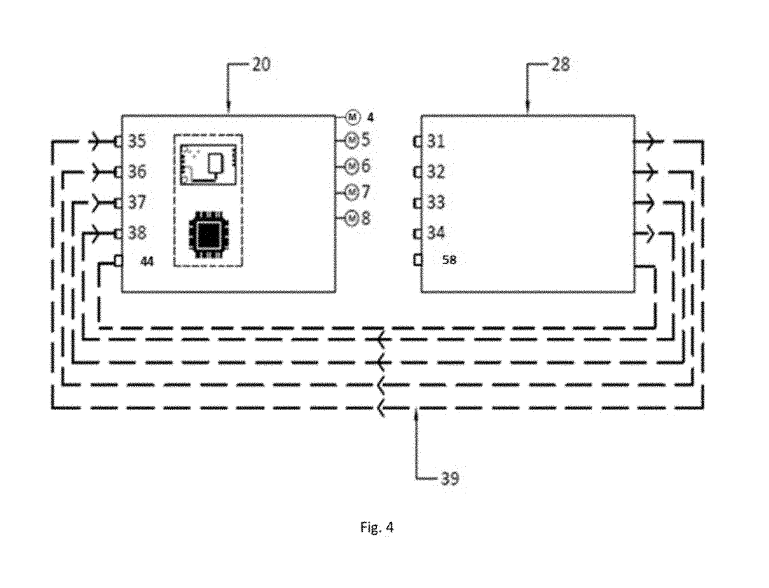

FIG. 4 shows a wireless connection (39) setup between control box (3) and remote station (2) to control various driving parameters of the vehicle (1) according to an example embodiment. The two control units of vehicle (1) and remote station (2) are shown. The microcontroller unit (20) of the vehicle (1) adaptively receives the input from the microcontroller unit (28) of remote station (2) establishing the wireless connection (39). The major control parameters are steering wheel, accelerator pedal, brake pedal and clutch pedal. In some vehicles, the clutch pedal may be optional. The status of these control parameters first recorded by control box (3) in the vehicles (1) and transmission of the same data in a coded format to the remote station (2) takes place at the input lines marked from 31-34 for accelerator, brake, clutch, gear and for steering control (58). The remote station (2) decodes the received data that is analyzed by the operator siting in the seat (18) and in response, the control signals generated by the operator and are transmitted back to the microcontroller unit (20) at input lines marked from (35-38) and (44) for controlling, accelerator pedal, brake pedal, clutch pedal, gear knob and steering wheel accordingly. The received control signals are used to actuate a motor mechanism that further controls the vehicle movement including other parameters. In an example embodiment, the motor mechanism includes stepper motors to provide a precise movement with a particular angular movement for controlling each and every parameter. Each control mechanism is separately connected to motor mechanism.

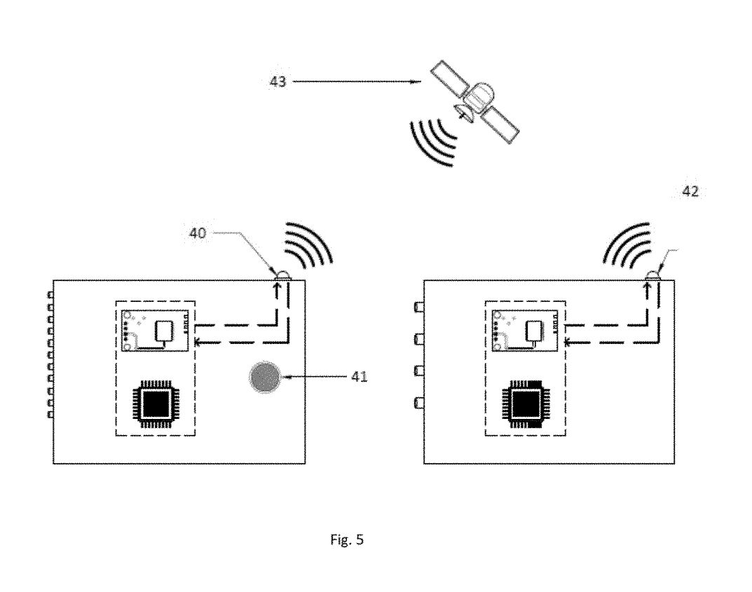

FIG. 5 shows a satellite enabled communication between remote station (2) and vehicle (1). In one embodiment of the disclosure, the control box (3) communicatively coupled with the remote station (2) via satellite communication (43) in such a manner that allows both devices to transmit and receive data in real-time at a very high data rate. A communication device (40) and a loudspeaker (41) are disposed on the vehicle (1) that enables it to communicate to remote station (2) or to an emergency contact number in case of any emergency situation like running out of fuel, tire puncture etc. occurs. The remote station is also provided with the similar communication device (42) for communicating with passenger or any emergency contact number during automatic driving mode of the vehicle.

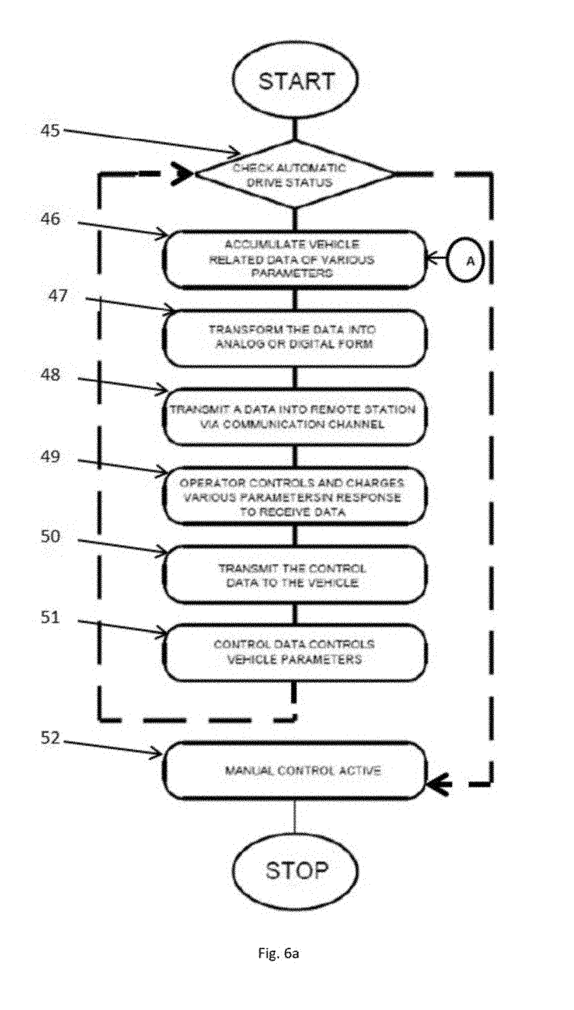

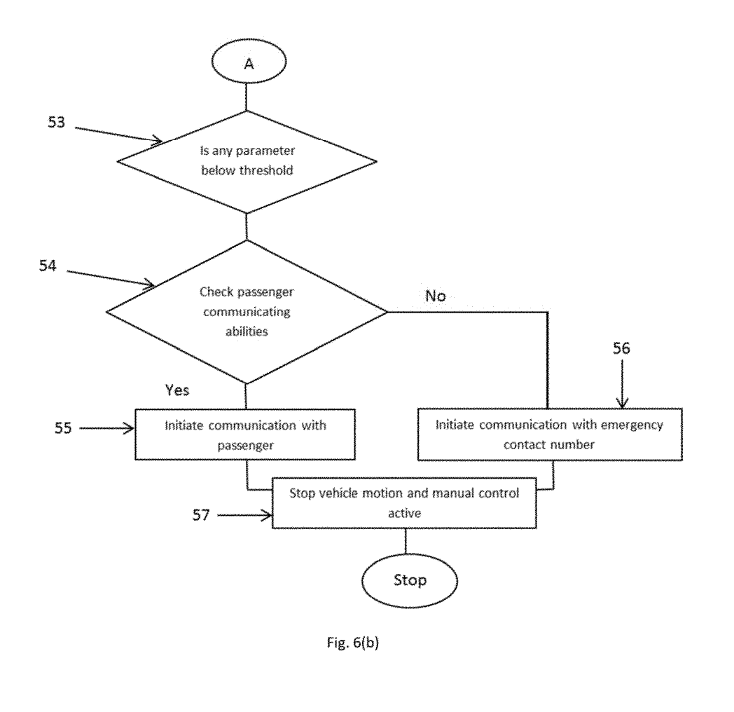

FIG. 6 (a) shows a flowchart explaining the remotely control mechanism of the vehicle (1) with remote station (2) and the exchange of data between the two devices. At step (45) the control, box checks the status of the automatic driving mode switch, if it is pressed then the further communication with remote station precedes otherwise the manual control remains active to drive manually by transferring the control to step (52). The activation of automatic driving mode triggers the sensors units along with cameras unit to accumulate the present status data of the various parameters of the vehicle during step (46). The accumulated data then transformed at step (47) into analog form for transmission and also into a digital format for storage in the storage media. This transformed data is transferred to remote station during step (48) via a communication channel. At step (49) this data received by the remote station and the operator analyzes the various parameters in a real-time and triggers various control operation depending on the status of data received. These operator triggered controls now transferred back to the control box via communication channel during step (50). The control box receives various control inputs from the remote station and forwards the same through its microcontroller unit to actuate motor mechanism to control various vehicle parameters at the end of step (51).

During data accumulation of various vehicle parameters at step (46) the control box designed to perform some additional operations and these are discussed with reference to the FIG. 6(a). FIG. 6a illustrates the various possible combinations for safe remote operation of vehicle driving. At step (53), the microcontroller coupled with the control box compares the values of all parameters with their specified threshold values and if any parameter deviates from its normal value then control operation proceeds to next. level otherwise it keep on monitoring the various parameters continuously. At step (54) the control operation checks for the passenger's ability to communicate with the remote station and in case the passenger manages the communication then a voice communication is established between the passenger and remote operator during step (55) else a communication setup established between remote operator and an emergency contact number proceeding, to step (56). At step (57), the microcontroller directs the motion of the vehicle to halt in case of any emergency or abrupt change in any parameters.

In an example embodiment of the disclosure a method for remotely-controlled driving of a vehicle without the intervention by the user traveling in the vehicle is provided. The system provided by the present disclosure is designed to help people travel in their vehicle when they are unable to drive the vehicle. Such users of the system includes, but not limited to elderly people, disabled people, people suffering from severe medical condition such as onset of chest pain, labor pain etc., people with suspended license and people under intoxication. The present disclosure can be used with the existing vehicles of the user. The present disclosure provides a system for remotely-controlled driving of a vehicle without the intervention by the user present in the vehicle. The remotely-controlled driving system generally comprises of a control box installed on the vehicle and a remote station present at a location away from the vehicle. The control box component includes an integrated circuit specifically a microcontroller or a micro-processor, which is connected to the various vehicle parameters of the vehicle, including, but not limited to the steering system, braking system, acceleration system, braking system and clutch system. The remotely controlled vehicle driving system also provides camera units to be installed in the vehicle to capture the view of the road where the vehicle is travelling. The control box is wirelessly connected to a satellite.

In another example embodiment of the present disclosure, the control box may be connected to the satellite through the GPS installed in the vehicle. The control box can receive I le travel path details from the GPS. The control box includes a transceiver to send signals to the remote station and also receive signals from the remote station via satellite. The remote station is also wirelessly connected to the satellite and includes a transceiver to send signals to the control box and also receive signals from the control box via satellite. The remote station also includes screens showing the view of the road where the vehicle is travelling, the path of the travel, the status of the steering wheel, fuel level, brake pedals, and other driving operators of the vehicle based on the signals received from the integrated circuit or microcontroller installed in the control box. The signals received from the integrated circuit includes data related to, including, but not limited to, driving operators of the vehicle, GPS system installed in the vehicle, vehicle speed, and fuel level. A human operator monitors the views on the screens in the remote station to review the data necessary to drive the vehicle. The remote station includes means fir sending control signals to the control box via satellite to help the operator to remotely drive the vehicle. The integrated circuit in the control box processes the received control signals and controls the driving operators of the vehicle in accordance with the command in the signal while the vehicle is driven. During the operation of the remotely-controlled driving system, the steering system, braking system, transmission system, and throttle system are controlled by the system and are locked for any manual intervention by the user travelling in the vehicle. Hence, the user travelling in the vehicle cannot drive the vehicle while the remotely-controlled driving system is under operation.

The integrated circuit has an on/off switch. The user can use the switch to switch the remotely-controlled driving system between manual driving mode and remotely-controlled driving mode. The manual driving mode relates to driver-controlled vehicle operation. The remotely-controlled driving system also includes a communication system connecting the control box with the remote station. The communication system is connected with the car speaker to generate sound signals when the remote station sends a message to the control box. The communication system also includes a microphone installed in the control box to collect voice message from the user present in the vehicle. The communication system, also includes a speaker and microphone installed in the remote station for use by the operator to communicate with the user present in the vehicle. The communication system includes, an on/off button present in the control box. The user can turn on the button to send a message to or receive a message from the operator in the remote station. In a preferred embodiment, the remotely-controlled driving method is implemented as a subscription based remotely-controlled driving service.

In another embodiment of the present disclosure, the remote operator is capable of controlling all additional parameters of the vehicles such as viper, horn, engine start/stop, door open/close, locking mechanism and interior temperature. In this way, the remote operator holds complete control on the vehicle and the remote operator is capable of controlling the vehicle like playing an arcade game in real time.

In one embodiment of the disclosure the user can easily communicate to the remotely-controlled driving service by using a computer application installed in his/her communication device such as cellular phone, laptop, computing devices etc. The subscription for the service may be operated by a company who manages the remotely-controlled driving system and operator working in the remote station. The user can use the remotely-controlled driving service by purchasing subscription of the remotely-controlled driving service. The subscription can be paid for monthly, quarterly or annually. The subscription can also be for a single journey and paid for as the user go on the journey, People who are unable to take care of the driving, for example, disabled people can take the subscription. In an embodiment of the present disclosure, a health insurance company can purchase the subscription of the remotely-controlled driving service, for a customer who is not able to drive himself/herself. The subscription of the remotely-controlled driving service may be provided only by an appointment only to provide a secured set up and preventing any misuse of the remotely-controlled driving service As mentioned earlier, the remotely-controlled driving service can also be implemented during emergency situations. The emergency situation may include, but not limited to, unexpected medical emergencies, a situation where someone hadn't planned on going out for a night of drinks and are too intoxicated to operate their vehicle. The medical emergency may include, but not limited to onset of chest pain, labor pains, etc. The remotely-controlled driving method can also be used by truck drivers and is thus highly useful to avoid road accidents. Under emergency situations, the remotely-controlled driving method would only be available to already existing customers. The use of remotely-controlled driving service for emergency situation can be charged extra for preventing misuse of the remotely-controlled driving service.

In a preferred embodiment of the present disclosure, for safe use of the remotely-controlled driving service, the user has to be of legal age to drive a vehicle as well as having a driving license which may be or may not be active, to support people with a suspended license. Further, to ensure safety, the operator present in the remote station has to undergo a series of tests to detect the presence of alcohol or any restricted drug before each remotely-controlled driving session. Another advantage of the remotely-controlled driving service of the present disclosure is that the remotely-controlled driving of the vehicle is available in bad weather conditions, such as stormy weather, rain, sleet or snow. The remotely-controlled driving service can be preferably provided around the year including on holidays. The user who is unable to manage the vehicle operations, for example, disabled people can also take a roadside assistance service, besides employing the remotely-controlled driving, which can be called in case an emergency occurs, for example, if a tire of the vehicle is punctured. The remotely-controlled driving service may provide an option for people unable to take care of driving and subscribing to the remotely-controlled driving service, to make an emergency contact, phone and email, so that a representative of the remotely-controlled driving service would send a complimentary call and or email to the user to notify them to refuel before the vehicle could be driven again under the remotely-controlled driving service. The user capable of taking care of driving may refuel with their local gas service.

In one another embodiment of the disclosure the night vision cameras can also be installed, that enables the operators to drive remote vehicle in night time without any problem.

Whereas, the construction and method have been described in relation to the above-given embodiments, it should be understood that other and further modifications, apart from those shown or suggested herein, may be made within the spirit and scope of this disclosure.

Accordingly, the specific embodiments discussed herein are merely illustrative of specific manners in which to make and use this disclosure, and are not intended to represent an exhaustive list of all possible structure and processes of the present disclosure.

Embodiments of the system for remotely controlling a vehicle from a rete to station are discussed above. While the structure and processes have been described with a certain degree of particularity, it is to be noted that many modifications may be made in the details of the structure and processes without departing from the spirit and scope of this disclosure. It is understood that the structure and processes are not limited to the embodiments set forth herein for purposes of exemplification.

While the above description regarding illustrative embodiments of the disclosed system includes examples of specific mounting devices, the present disclosure is not limited to those specific examples. It is to be understood that the above description is intended to be illustrative, and not restrictive. For example, the above discussed embodiments may be used in combination with each other. Many other embodiments will be apparent to those of skill in the art upon reviewing the above description.

Whereas, the construction and method have been described in relation to the above-given embodiments, it should be understood that other and further modifications, apart from those shown or suggested herein, may be made within the spirit and scope of this disclosure.

What is claimed is:

1. A method for remotely controlling a vehicle, the method comprising:
retrieving at least one vehicle parameter by a control unit, the control unit including a first memory and a first processor, and a communication unit;
transmitting said at least one vehicle parameter to a remote station, the remote station including a second memory, a second processor, and a communication device;
determining a status of said at least one vehicle parameter by said remote station;
generating at least one control signal based on said determined status of vehicle parameters;
transmitting said control signals to said control unit;
receiving said control signals by said control unit; and
actuating at least one vehicle component based on said received control signal; wherein said at least one vehicle component is configured to perform a predefined function based on said control signal.

2. The method as claimed in claim 1, wherein said step of retrieving at least one vehicle parameter includes obtaining vehicle and surrounding information from a pair of front and rear cameras and form a plurality of sensors.

3. The method as claimed in claim 2, wherein said Plurality of sensors are configured to monitor a plurality of vehicle components, the vehicle components being at least one of a steering wheel, acceleration pedal, brake pedal, clutch pedal, gear shift knob and combination thereof.

4. The method as claimed in claim 1, wherein said step of transmitting includes communicating the vehicle parameters from said control unit to said remote station via a wireless communication channel.

5. The method as claimed in claim 1, wherein said step of determining status of at least one vehicle parameter includes comparing said at least one vehicle parameter with a threshold value.

6. The method as claimed in claim 5, wherein said threshold value includes a preset value corresponding to at least one vehicle parameters.

7. The method as claimed in claim 1, wherein said step of generating control signal includes generating control signals based on user is operation of the remote station to generate control signals.

8. The method as claimed in claim 1, wherein generating control signal includes inputting a plurality of values based on operation by an operator to control said remote vehicle.

9. The method as claimed in claim 1, wherein said step of transmitting said control signals includes communicating said control signals from said remote station to said control unit via said communication channel.

10. The method as claimed in claim 1, wherein the control signals are transferred to a processor of said control unit.

11. The method as claimed in claim 1, wherein said step of actuating at least one vehicle component includes processing said control signals to control said vehicle components.

12. The method as claimed in claim 1, wherein said at least one vehicle parameter is selected from the group of steering wheel control parameter, accelerator control parameter, brake control parameter, gear control parameter, clutch control parameter and combination thereof.

13. The method as claimed in claim 1, wherein said remote station further comprises a pair of display units, and a plurality of peripheral devices.

14. The method as claimed in claim 1, wherein said at least one control signal is selected from the group of steering wheel rotation control signal, acceleration pedal control signal, brake pedal control signal, gear shift knob control signal, clutch pedal control signal and combination thereof.

15. The method as claimed in claim 1, wherein said at least one vehicle component is selected from steering wheel, acceleration pedal, brake pedal, gear shift knob, clutch pedal, fuel level, instantaneous speed, air pressure in tires and combination thereof.

16. The method as claimed in claim 1, wherein said predefined function includes controlling steering movement, acceleration, brake, clutch, gear shifting and combination thereof.

17. A system for remotely controlling a vehicle, comprising:
a control unit including a first processor and a memory, wherein the first memory comprises a non-transitory computer-readable-medium having computer-executable instructions stored therein that, when executed by the first processor, cause the first processor to,
retrieve at least one vehicle parameter, and
transmit said at least one vehicle parameter to a remote station;
wherein,
the remote station includes a second processor and a second memory, wherein the second memory comprises a non-transitory computer-readable-medium having computer-executable instructions stored therein that, when executed by the second processor, cause said second processor to,
receive said at least one vehicle parameter,
determine a status of said at least one vehicle parameter,
generate at least one control signal based on said determined status of vehicle parameters, and
transmit said control signal to said control unit; wherein,
said control unit is further configured to,
receive said control signals; and
actuate at least one vehicle component based on said received control signal; and wherein said at least one vehicle component is configured to perform a predefined function based on said control signal.

18. The system as claimed in claim 17, wherein said at least one vehicle parameter is selected from the group of steering wheel control parameter, accelerator control parameter, brake control parameter, gear control parameter, clutch control parameter and combination thereof.

19. The system as claimed in claim 17, wherein said remote station comprises a pair of display units, a communication device and a plurality of peripheral devices.

20. The system as claimed in claim 17, wherein said at least one control signal is selected from the group of steering wheel rotation control signal, acceleration pedal control signal, brake pedal control signal, gear shift knob control signal, clutch pedal control signal and combination thereof.

21. The system as claimed in claim 17, wherein said at least one vehicle component is selected from steering wheel, acceleration pedal, brake s pedal, gear shift knob, clutch pedal, fuel level, instantaneous speed, air pressure in tires and combination thereof.

22. The system as claimed in claim 17, wherein said predefined function includes controlling steering movement, acceleration, brake, clutch, gear shifting and combination thereof.

23. The system as claimed in claim 17, wherein a plurality of sensors are configured to sense a relative speed, proximity, and size of the travelling vehicles in surrounding of the vehicle and send the sensed signal to the remote station.

24. The system as claimed in claim 23, wherein determining status of the vehicle parameter further include generating a plurality of safety contour loops around the vehicle based on the sensed signal data.

25. The system as claimed in claim 23, wherein the plurality of sensors includes acoustic sensors.

26. The system as claimed in claim 24, wherein determining the status of the vehicle parameter further includes sending one or more such safety contour loops to the remote operator based on whether a travelling vehicle in the surrounding enters or approaches close to one or more safety contour loops.
